(19) United States
(12) Patent Application Publication
(10) Pub. No.: US 2015/0142575 A1
(43) Pub. Date: May 21, 2015

(54) METHOD AND SYSTEM FOR TARGETED ADVERTISING ON CLOTHING

(71) Applicant: MasterCard International Incorporated, Purchase, NY (US)

(72) Inventors: Jean-Pierre GERARD, Croton-On-Hudson, NY (US); Po HU, Norwalk, CT (US); Arun ELANGOVAN, Astoria, NY (US)

(73) Assignee: MasterCard International Incorporated, Purchase, NY (US)

(21) Appl. No.: 14/082,845

(22) Filed: Nov. 18, 2013

(51) Int. Cl. G06Q 30/02

(52) U.S. Cl. CPC G06Q 30/0269; G06Q 30/0267
USPC 705/14.64

(57) ABSTRACT

A method for displaying targeted content on an article of clothing includes: storing a plurality of consumer profiles, each consumer profile including a consumer identifier and consumer behavioral data; storing a plurality of content profiles, each content profile including data related to a visual content item including one or more selection criteria; reading payment card data corresponding to a payment card associated with a specific consumer, the payment card data including a specific consumer identifier associated with the specific consumer; identifying a specific consumer profile where the included consumer identifier corresponds to the specific consumer identifier; identifying a specific content profile based on the one or more selection criteria and the consumer behavioral data included in the identified specific consumer profile; and transmitting the visual content item included in the identified specific content profile for display on an article of clothing directed toward the specific consumer.

### FIELD

The present disclosure relates to the displaying of targeted content on an article of clothing, specifically the selection of content targeted to an identified consumer and display thereof on clothing worn by an employee for advertising to the identified consumer.

### BACKGROUND

Many entities, such as merchants, manufacturers, retailers, offer providers, advertisers, and others, use advertising and content display (e.g., coupons, offers, deals, etc.) in an effort to entice consumers to purchase specific products or services or to engage in commerce with a particular merchant or business. In order to increase the effectiveness of such content distribution, many entities identify content that is specifically targeted for a consumer based on information available about the consumer. For example, a merchant may identify the interests of a consumer, based on a survey, past purchases, social network information, etc., and may then select advertisements to display to the consumer based on their interests.

However, even the most specifically targeted advertisement may be ineffective if it is not also observed and/or acknowledged by the consumer to whom it is targeted. For example, one such method for distributing targeted content to a consumer includes printing out a coupon targeted to the consumer to accompany a receipt of a conducted transaction. However, many consumers neglect to review their receipts unless a problem with a purchase is discovered. As a result, many such coupons go unnoticed, and thus are ineffective at influencing the consumer's behavior.

Thus, there is a need for a technical solution to provide for the distribution of targeted advertising to a consumer in a manner more likely to be effectively received by the consumer and therefore more likely to be acted upon.

### SUMMARY

The present disclosure provides a description of systems and methods for displaying targeted content on an article of clothing.

A method for displaying targeted content on an article of clothing includes: storing, in a consumer database, a plurality of consumer profiles, wherein each consumer profile includes data related to a consumer including at least a consumer identifier and consumer behavioral data; storing, in a content database, a plurality of content profiles, wherein each content profile includes data related to a visual content item including at least one or more selection criteria; reading, by a reading device, payment card data corresponding to a payment card associated with a specific consumer, wherein the payment card data includes at least a specific consumer identifier associated with the specific consumer; identifying, in the consumer database, a specific consumer profile where the included consumer identifier corresponds to the specific consumer identifier; identifying, in the content database, a specific content profile based on the included at least one or more selection criteria and the consumer behavioral data included in the identified specific consumer profile; and transmitting, by a transmitting device, the visual content item included in the identified specific content profile for display on an article of clothing directed toward the specific consumer.

A system for displaying targeted content on an article of clothing includes a consumer database, a content database, a reading device, a processing device, and a transmitting device. The consumer database is configured to store a plurality of consumer profiles, wherein each consumer profile includes data related to a consumer including at least a consumer identifier and consumer behavioral data. The content database is configured to store a plurality of content profiles, wherein each content profile includes data related to a visual content item including at least one or more selection criteria. The reading device is configured to read payment card data corresponding to a payment card associated with a specific consumer, wherein the payment card data includes at least a specific consumer identifier associated with the specific consumer. The processing device is configured to: identify, in the consumer database, a specific consumer profile where the included consumer identifier corresponds to the specific consumer identifier; and identify, in the content database, a specific content profile based on the included at least one or more selection criteria and the consumer behavioral data included in the identified specific consumer profile. The transmitting device is configured to transmit the visual content item included in the identified specific content profile for display on an article of clothing directed toward the specific consumer.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a high level architecture illustrating a system for displaying targeted content on articles of clothing in accordance with exemplary embodiments.

FIG. 2 is a block diagram illustrating the processing server of FIG. 1 for the identification and distribution of targeted content for display on an article of clothing in accordance with exemplary embodiments.

FIG. 3 is a flow diagram illustrating a process for the selecting and display of targeted content on an article of clothing using the system of FIG. 1 in accordance with exemplary embodiments.

FIG. 4 is a flow diagram illustrating a method for the identification and transmission of targeted content by the processing server of FIG. 1 in accordance with exemplary embodiments.

FIG. 5 is a flow chart illustrating an exemplary method for displaying targeted content on an article of clothing in accordance with exemplary embodiments.

FIG. 6 is a block diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### Definition of Terms

Payment Network—A system or network used for the transfer of money via the use of cash-substitutes. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, checks, financial accounts, etc. Examples of networks or systems configured to perform as payment networks include those operated by MasterCard®, VISA®, Discover®, American Express®, etc.

Payment Account—A financial account that may be used to fund a transaction, such as a checking account, savings account, credit account, virtual payment account, etc. A payment account may be associated with an entity, which may include a person, family, company, corporation, governmental entity, etc. In some instances, a payment account may be virtual, such as those accounts operated by PayPal®, etc.

Payment Card—A card or data associated with a payment account that may be provided to a merchant in order to fund a financial transaction via the associated payment account. Payment cards may include credit cards, debit cards, charge cards, stored-value cards, prepaid cards, fleet cards, virtual payment numbers, virtual card numbers, controlled payment numbers, etc. A payment card may be a physical card that may be provided to a merchant, or may be data representing the associated payment account (e.g., as stored in a communication device, such as a smart phone or computer). For example, in some instances, data including a payment account number may be considered a payment card for the processing of a transaction funded by the associated payment account. In some instances, a check may be considered a payment card where applicable.

### System for Displaying Targeted Advertising on Clothing

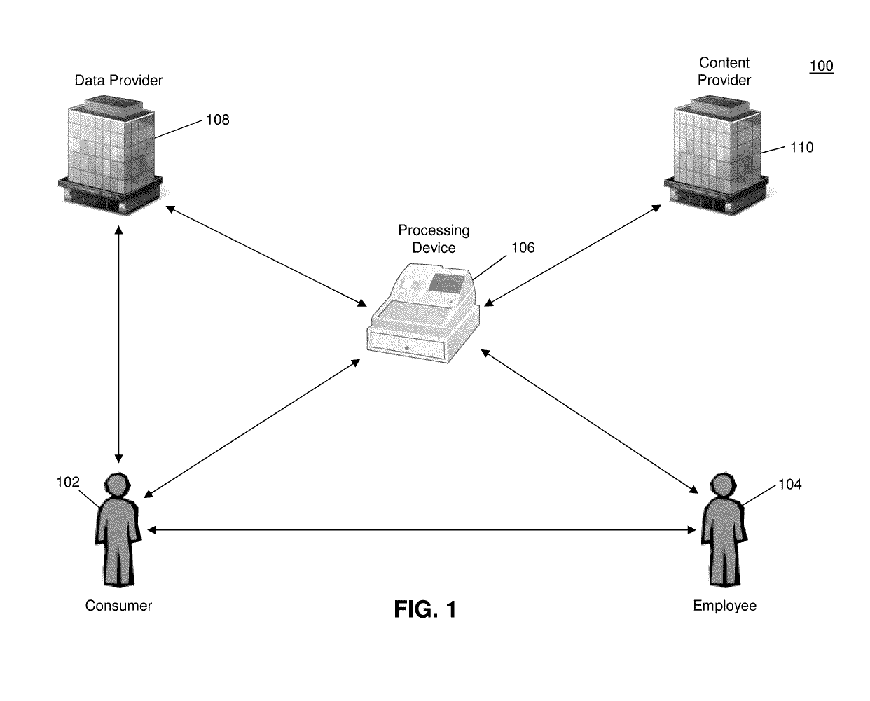

FIG. 1 illustrates a system 100 for the display of targeted content on articles of clothing based on consumer data.

The system 100 may include a consumer 102. The consumer 102 may visit a merchant and engage in a payment transaction for the purchase of goods or services. The consumer 102 may approach an employee 104, such as a sales clerk, in order to initiate and conduct the payment transaction. The employee 104 may wear an article of clothing that is configured to display content to the consumer 102, such as textile-based light-emitting diode display or suitable type of clothing, such as Lumalive by Philips.

The employee 104 may enter transaction data into a processing device 106, such as a point-of-sale device. The processing device 106, discussed in more detail below, may receive and store product data for one or more products (e.g., goods and/or services) to be purchased by the consumer 102. Methods for entering product data into the processing device 106 will be apparent to persons having skill in the relevant art and may include entering of product data manually using an input device by the employee 104, the reading of product data via a reading device (e.g., a bar code scanner), etc.

Once the product data has been entered, the processing device 106 may display a total transaction amount for the transaction that the consumer 102 is due to pay. The consumer 102 may present payment information associated with a payment account to be used to fund the payment transaction. The consumer 102 may present the payment information via a payment card, via display by a mobile communication device, via near field communication using a mobile communication device, or other suitable method as will be apparent to persons having skill in the relevant art. The processing device 106 may then read or otherwise receive the payment information using an appropriate method based on the presentation of the payment information.

The system 100 may further include a data provider 108. The data provider 108 may be configured to collect behavioral data associated with the consumer 102, such as demographics data, transaction data, advertising effectiveness data, offer redemption data, etc. In some embodiments, the data provider 108 may not include any personally identifiable information of the consumer 102. The data provider 108 may be configured to provide the behavioral data associated with the consumer 102 to the processing device 106.

In some instances, the processing device 106 may be configured to transmit a request to the data provider 108 for the behavioral data associated with the consumer 102. For example, the processing device 106 may transmit a request to the data provider 108 including an identifier associated with the consumer 102, such as a payment account number included in the payment information, once the payment information has been received. The data provider 108 may then identify the behavioral information associated with the consumer 102 using the included identifier, and respond to the request by providing the behavioral information to the processing device 106. In other instances, the data provider 108 may regularly provide consumer data to the processing device 106, which may then store the data in consumer profiles associated with the corresponding consumers. In one example, the data provider 108 may provide such data to the processing device 106 at predetermined periods of time (e.g., daily, weekly, monthly, anytime data for a consumer is updated, etc.).

The system 100 may also include a content provider 110. The content provider 110 may provide a plurality of content items to the processing device 106. The content items may include visual content items that are configured to be displayed to the consumer 102 via the article of clothing worn by the employee 104. In some instances, the processing device 106 may receive content items to be stored in a content database and identified based on the consumer behavioral data associated with the consumer 102. In other instances, the processing device 106 may provide the consumer behavioral data to the content provider 110 in a request for content. The content provider 110 may then identify a content item based thereon and provide the identified content item to the processing device 106.

Once a content item that has been targeted to the consumer 102 has been identified, the processing device 106 may transmit the content item to the article of clothing worn by the employee. The article of clothing may then display the content item to the consumer 102 as the transaction is conducted.

It will be apparent to persons having skill in the relevant art that the example discussed herein is provided as means of illustration only, and that other configurations of the system 100 may be suitable to provide for the display of targeted advertising on an article of clothing consistent with the present disclosure. For example, in some embodiments, the consumer 102 may be identified upon entering a merchant location, such as via a mobile communication device, by swiping their payment card, by swiping a loyalty card or other means of identification, etc. The processing device 106 may then identify the consumer 102 and subsequently identify targeted content using the methods and systems discussed herein. The clothing worn by the employee 104 may then display the targeted content to the consumer 102 during the consumer's purchase experience and prior to the conducting of a payment transaction.

The use of clothing to display targeted content may provide a number of benefits over existing methods for distributing targeted content to consumers. For example, many consumers regularly interact with employees during payment transactions at a merchant. Thus, a consumer may be more likely to notice and therefore be influenced by an advertisement displayed on the employee's person than an advertisement displayed on a point-of-sale or receipt, or delivered to the consumer separately, such as via e-mail. Such content display may therefore be more effective than traditional methods for displaying content to a consumer, and thus result in greater efficiency and therefore increased benefit to the content providers, as well as the consumers.

### Processing Device

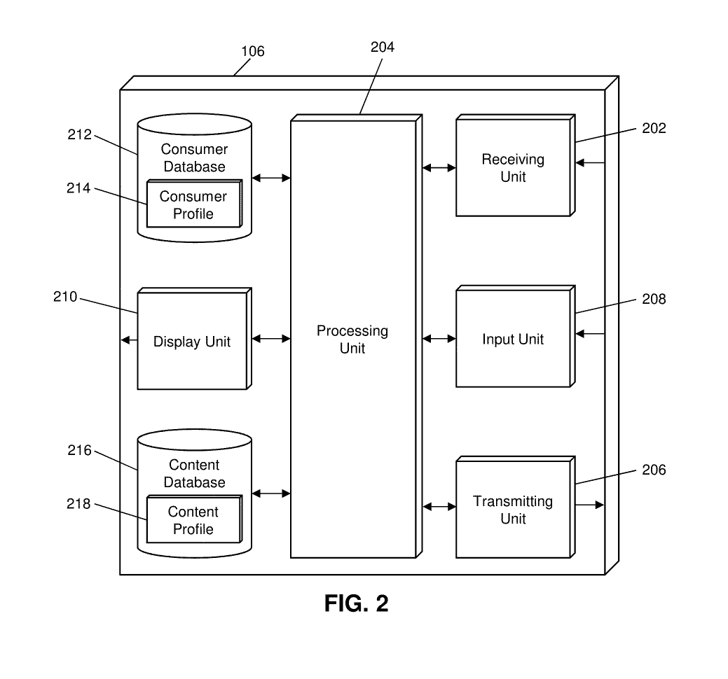

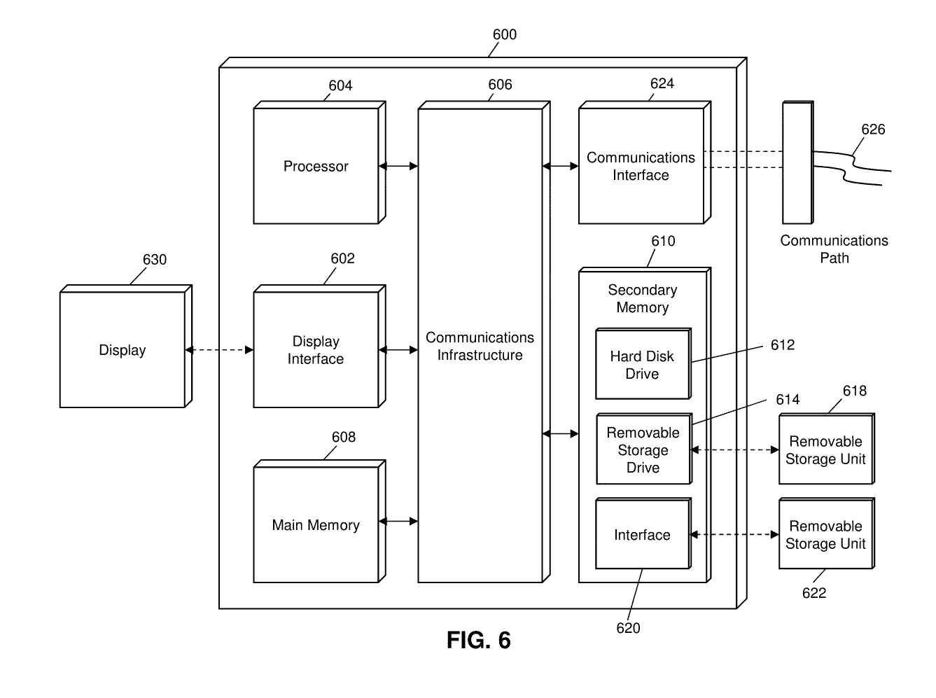

FIG. 2 illustrates an embodiment of the processing device 106 of the system 100. It will be apparent to persons having skill in the relevant art that the embodiment of the processing device 106 illustrated in FIG. 2 is provided as illustration only and may not be exhaustive to all possible configurations of the processing device 106 suitable for performing the functions as discussed herein. For example, the computer system 600 illustrated in FIG. 6 and discussed in more detail below may be a suitable configuration of the processing device 106.

The processing device 106 may include a receiving unit 202. The receiving unit 202 may be configured to receive data over one or more networks via one or more network protocols. The receiving unit 202 may be configured to receive consumer data from the data provider 108, such as consumer behavioral data associated with one or more consumers 102. The processing device 106 may further include a processing unit 204. The processing unit 204 may be configured to store the received consumer data in a consumer database 212 as a plurality of consumer profiles 214.

Each consumer profile 214 may include data related to a consumer 102 including at least a consumer identifier and consumer behavioral data. The consumer identifier may be a unique value suitable for identifying the associated consumer 102, such as a payment account number or other information encoded in a payment card, name, e-mail address, identification number, or other suitable value as will be apparent to persons having skill in the relevant art. The consumer behavioral data may include any information suitable of the identification of content to be distributed to the associated consumer 102, such as demographic data, transaction data, advertising data, offer data, and consumer-supplied data.

The receiving unit 202 may be further configured to receive content data from the content provider 110. The processing unit 204 may store the received content data in a content database 216 as a plurality of content profiles 218. Each content profile 218 may include data related to a visual content item to be displayed to a consumer 102 including at least the visual content and one or more selection criteria. The one or more selection criteria may include criteria for selecting the associated content profile 218 among all of the content profiles 218 based on the consumer behavioral data for a specific consumer 102. In some instances, selection of a content profile 218 may be based on a consumer score calculated based on the consumer behavioral data. In such an instance, the one or more selection criteria may include a model score for use in selecting the associated content profile 218 based on the model score and calculated consumer score.

The visual content may be a data file of a media type corresponding to an image or video that may be suitable for display on the article of clothing worn by the employee 104. Suitable types of visual content will be apparent to persons having skill in the relevant art. In some embodiments, content profiles 218 may further include a corresponding geographic location. In such an embodiment, selection of a content profile 218 may be further based on the included corresponding geographic location and a geographic location of the processing device 106. For example, only content items whose corresponding location is within a predetermined distance from the processing device 106 may be eligible for display to the consumer 102.

The processing device 106 may further include an input unit 208. The input unit 208 may be configured to receive input from one or more input devices, such as a keyboard, mouse, reading device (e.g., optical (e.g., barcode) scanner, magnetic stripe reader, etc.), camera, microphone, or other suitable input device as will be apparent to persons having skill in the relevant art. The input unit 208 may be configured to receive product data for one or more products to be purchased by the consumer 102 and to receive payment information regarding a payment method used by the consumer 102 to fund a payment transaction.

In some embodiments, the input unit 208 may receive encoded and/or encrypted payment information, such as payment information encoded in a payment card presented by the consumer 102. In such an embodiment, the processing unit 204 may be configured to decode and/or decrypt the received information to obtain payment information for the payment transaction. The processing unit 204 may be configured to identify a consumer identifier associated with the consumer 102 included in the received payment information. The processing unit 204 may then identify a consumer profile 214 in the consumer database 212 associated with the consumer 102 based on the consumer identifier, and then identify a content profile 218 based on the consumer behavioral data included in the identified consumer profile 214, as discussed in more detail below.

The processing device 106 may further include a transmitting unit 206. The transmitting unit 206 may be configured to transmit data over one or more networks via one or more network protocols. The transmitting unit 206 may transmit the visual content associated with the identified content profile 218 for display on the article of clothing worn by the employee 104. In some instances, the transmitting unit 206 and/or the processing unit 204 may format the content item in a suitable format for display on the article of clothing as will be apparent to persons having skill in the relevant art.

The processing device 106 may further include a display unit 210. The display unit 210 may be any type of display suitable for performing the functions as disclosed herein, such as a liquid crystal display, light-emitting diode display, capacitive touch display, cathode ray tube display, etc. The display unit 210 may include one or more displays and be configured to display data to the employee 104 and/or the consumer 102, such as for product data corresponding to products to be purchased, a transaction amount, transaction status, etc. It will be further apparent to persons having skill in the relevant art that the display unit 210 and the other units of the processing device 106 may be further configured to perform functions of a point-of-sale device in order to conduct and process payment transactions.

### Process for Displaying Targeted Content on an Article of Clothing

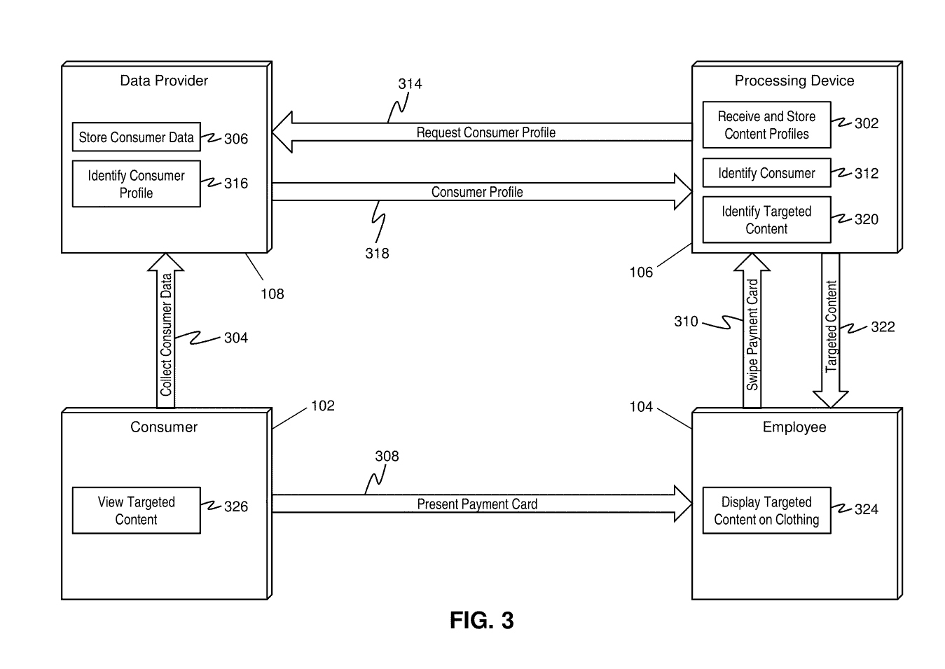

FIG. 3 illustrates a process for the display of targeted content on an article of clothing using the system 100 of FIG. 1.

In step 302, the processing device 106 may receive (e.g., via the receiving unit 202) content items from the content provider 110 and store the content items and corresponding selection criteria in one or more content profiles 218 in the content database 216. In step 304, the data provider 108 may collect consumer data from the consumer 102. The consumer data may include demographic information associated with the consumer 102, transaction data for transactions involving the consumer 102, data supplied directly from the consumer 102, consumer behavior regarding previous content items distributed to the consumer 102, etc. In step 306, the data provider 108 may store the consumer data in a consumer profile associated with the consumer 102.

In step 308, the consumer 102 may present a payment card associated with a payment account corresponding to the consumer 102 to the employee 104. In some instances, the consumer 102 may present the payment card as part of a payment transaction being conducted by and/or with the employee 104. In step 310, the employee 104 may swipe the payment card in the processing device 106 (e.g., via the input unit 208), such that the processing device 106 may obtain the payment information encoded in the payment card. It will be apparent to persons having skill in the relevant art that additional methods for reading the payment information in the processing device 106 may be used. For example, the input unit 208 of the processing device 106 may receive the payment information via near field communication from a mobile device associated with the consumer 102 or read the information as encoded in a machine-readable code displayed by a mobile device associated with the consumer 102.

In step 312, the processing device 106 may identify the consumer 102 via identification of a consumer identifier included in the read and/or received payment information. In step 314, the processing device 106 may transmit a request for a consumer profile associated with the consumer 102 to the data provider 108, wherein the request includes at least the consumer identifier. In step 316, the data provider 108 may identify the consumer profile associated with the consumer 102 based on the received consumer identifier.

In step 318, the data provider 108 may return the identified consumer profile to the processing device 106 in response to the previously submitted consumer profile request. It will be apparent to persons having skill in the relevant art that, in some embodiments, step 316 may be performed by the processing unit 204 of the processing device 106 in instances where the processing device 106 includes a consumer database 212 for storing the consumer profiles 214.

In step 320, the processing device 106 may identify a content profile 218 stored in the content database 216 based on the included one or more selection criteria and the consumer behavioral data included in the identified and/or received consumer profile. In step 322, the processing device 106 may transmit (e.g., via the transmitting unit 206) the visual content associated with the identified content profile 218 for display on the article of clothing worn by the employee 104. In step 324, the article of clothing may display the received visual content item for viewing by the consumer 102.

### Process for Identifying a Targeted Visual Content Item

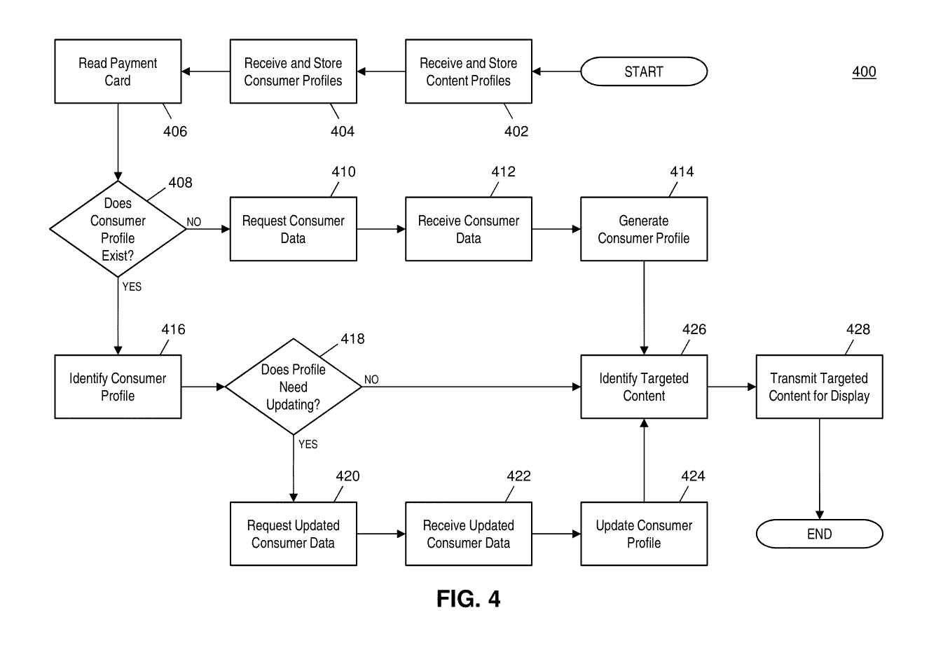

FIG. 4 illustrates a process 400 of the processing device 106 for the identification of targeted visual content based consumer behavioral data and transmission thereof for display on an article of clothing.

In step 402, the receiving unit 202 of the processing device 106 may receive content profiles from the content provider 110 for storage in the content database 216 by the processing unit 204 as content profiles 218. The content profiles 218 may include a visual content item and one or more selection criteria. In step 404, the receiving unit 202 may receive consumer data from a data provider 108 for storage in the consumer database 212 by the processing unit 204 as consumer profiles 214. Each consumer profile 214 may include a consumer identifier and consumer behavioral data associated with a related consumer 102.

In step 406, the processing device 106 may read (e.g., via the input unit 208) payment card data encoded in a payment card, where the payment card data includes at least a specific consumer identifier. In step 408, the processing unit 204 may determine if a corresponding consumer profile 214 exists in the consumer database 212 where the included consumer identifier corresponds to the specific consumer identifier.

If no associated consumer profile 218 exists, then, in step 410, the transmitting unit 206 may transmit a request for consumer data to the data provider 108, the request including the specific consumer identifier. In step 412, the receiving unit 202 may receive consumer behavioral data from the data provider 108 corresponding to the specific consumer identifier. In step 414, the processing unit 204 may generate a new consumer profile 214 including the specific consumer identifier and the newly received consumer behavioral data and store the newly generated consumer profile 214 in the consumer database 212.

If, in step 408, the processing unit 204 determines a consumer profile 218 does exist, then, in step 416, the processing unit 204 may identify the existing consumer profile 218 where the included consumer identifier corresponds to the specific consumer identifier. In step 418, the processing unit 204 may determine if the identified consumer profile 218 needs updating prior to the identification of content for display. The processing unit 204 may identify that the consumer profile 218 needs updating based on time passed since a previous update, available time for updating of the profile 218, and other considerations that will be apparent to persons having skill in the relevant art.

If the consumer profile 218 needs updating, then, in step 420, the transmitting unit 206 may transmit a request for updated consumer data to the data provider 108, wherein the request includes at least the specific consumer identifier. In some instances, the request may further include a time and/or date to be used by the data provider 108 for the identification of updated consumer data. For example, the processing device 106 may request only consumer behavioral data updated since the most previous update. In step 422, the receiving unit 202 may receive the updated consumer data from the data provider 108 and, in step 424, the processing unit 204 may update the consumer profile 218 to include the updated consumer data.

Once the consumer profile 218 is updated, if necessary, or newly generated, then, in step 426, the processing unit 204 may identify a content profile 218 in the content database 216 based on the included one or more selection criteria and the consumer behavioral data included in the consumer profile 218. In some embodiments, the processing unit 204 may be configured to calculate a consumer score based on one or more scoring rules and/or algorithms and the consumer behavioral data included in the consumer profile 218. In such an embodiment, the processing unit 204 may identify a content profile 218 based on the calculated consumer score, such as by corresponding the calculated consumer score with a model score included in the content profile 218. In some instances, multiple scores may be calculated and/or corresponded, such as a score for each of a plurality of criteria. Additional criteria and methods for the identification of a content item targeted to a specific consumer based on consumer behavioral data will be apparent to persons having skill in the relevant art.

In step 428, the transmitting unit 206 may transmit the visual content corresponding to the identified content profile 218 for display on the article of clothing worn by the employee 104. The consumer 102 may then view the specifically targeted content as displayed on the clothing of the employee 104.

### Exemplary Method for Displaying Targeted Content on an Article of Clothing

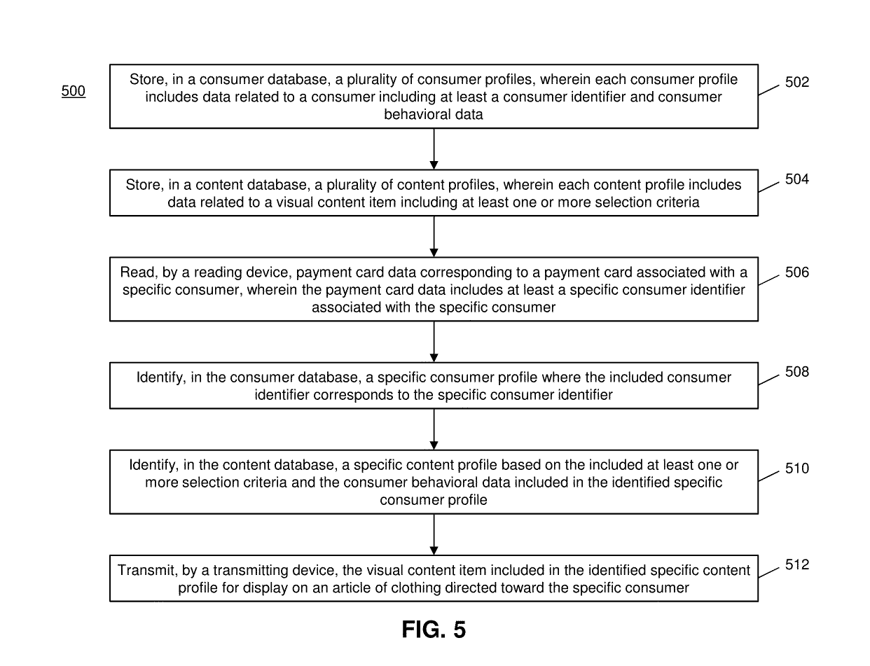

FIG. 5 illustrates an exemplary method 500 for the display of targeted content of an article of clothing based on consumer behavioral data.

In step 502, a plurality of consumer profiles (e.g., consumer profiles 214) may be stored, in a consumer database (e.g., the consumer database 212), wherein each consumer profile 214 includes data related to a consumer (e.g., the consumer 102) including at least a consumer identifier and consumer behavioral data. In one embodiment, the consumer behavioral data may include at least one of: transaction data, demographic data, advertising data, offer data, and consumer-supplied data. In some embodiments, the consumer identifier may be at least one of: a payment account number corresponding to the payment card and a name.

In step 504, a plurality of content profiles (e.g., content profiles 218) may be stored, in a content database (e.g., the content database 216), wherein each content profile 218 includes data related to a visual content item including at least one or more selection criteria. In one embodiment, the visual content item may be at least one of: an advertisement, offer, deal, discount, or coupon for a good or service. In some embodiments, the visual content item may be a data file having a media type corresponding to an image or video.

In step 506, payment card data may be read, by a reading device (e.g., the input unit 208), corresponding to a payment card associated with a specific consumer 102, wherein the payment card data includes at least a specific consumer identifier associated with the specific consumer 102. In one embodiment, reading the payment card data may include reading, by the reading device, card data encoded in a payment card and decoding, by a processing device (e.g., the processing unit 204), the read card data to obtain the payment card. In another embodiment, reading the payment card data may include reading, by the reading device, card data encoded in a machine-readable code and decoding, by the processing device 204, the read card data to obtain the payment card data. In a further embodiment, the machine-readable code may be a bar code, such as a QR code. In yet another embodiment, reading the payment card data may include receiving, by a receiving device (e.g., the receiving unit 202), encrypted data via near field communication and decrypting, by the processing device 204, the received encrypted data to obtain the payment card data.

In step 508, a specific consumer profile 214 may be identified, in the consumer database 212, where the included consumer identifier corresponds to the specific consumer identifier. In step 510, a specific content profile 218 may be identified, in the content database 216, based on the included at least one or more selection criteria and the consumer behavioral data included in the identified specific consumer profile 214. In one embodiment, the one or more selection criteria may include at least one model score. In such an embodiment, step 510 may further include: identifying, based on at least the consumer behavioral data included in the specific consumer profile, a consumer score; and identifying, by the processing device 204, the specific content profile 218 based on a correspondence between the included at least one model score and the identified consumer score.

In another embodiment, each content profile 218 may include a corresponding geographic location, and identification of the specific content profile 218 may be further based on a distance between the included corresponding geographic location and a predetermined geographic location. In yet another embodiment, the method 500 may further include storing, in a memory, product data corresponding to one or more products to be purchased by the specific consumer 102, wherein identification of the specific consumer profile 218 is further based on the stored product data. In step 512, the visual content item included in the identified specific content profile 218 may be transmitted, by a transmitting device (e.g., the transmitting unit 206) for display on an article of clothing directed towards the specific consumer 102.

### Computer System Architecture

FIG. 6 illustrates a computer system 600 in which embodiments of the present disclosure, or portions thereof, may be implemented as computer-readable code. For example, the processing device 106 of FIG. 1 may be implemented in the computer system 600 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 3-5.

If programmable logic is used, such logic may execute on a commercially available processing platform or a special purpose device. A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 618, a removable storage unit 622, and a hard disk installed in hard disk drive 612.

Various embodiments of the present disclosure are described in terms of this example computer system 600. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor 604 may be a special purpose or a general purpose processor device. The processor 604 may be connected to a communications infrastructure 606, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 600 may also include a main memory 608 (e.g., random access memory, read-only memory, etc.), and may also include a secondary memory 610. The secondary memory 610 may include the hard disk drive 612 and a removable storage drive 614, such as a floppy disk drive, a magnetic tape drive, an optical disk drive, a flash memory, etc.

The removable storage drive 614 may read from and/or write to the removable storage unit 618 in a well-known manner. The removable storage unit 618 may include a removable storage media that may be read by and written to by the removable storage drive 614. For example, if the removable storage drive 614 is a floppy disk drive, the removable storage unit 618 may be a floppy disk. In one embodiment, the removable storage unit 618 may be non-transitory computer readable recording media.

In some embodiments, the secondary memory 610 may include alternative means for allowing computer programs or other instructions to be loaded into the computer system 600, for example, the removable storage unit 622 and an interface 620. Examples of such means may include a program cartridge and cartridge interface (e.g., as found in video game systems), a removable memory chip (e.g., EEPROM, PROM, etc.) and associated socket, and other removable storage units 622 and interfaces 620 as will be apparent to persons having skill in the relevant art.

Data stored in the computer system 600 (e.g., in the main memory 608 and/or the secondary memory 610) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 600 may also include a communications interface 624. The communications interface 624 may be configured to allow software and data to be transferred between the computer system 600 and external devices. Exemplary communications interfaces 624 may include a modem, a network interface (e.g., an Ethernet card), a communications port, a PCMCIA slot and card, etc. Software and data transferred via the communications interface 624 may be in the form of signals, which may be electronic, electromagnetic, optical, or other signals as will be apparent to persons having skill in the relevant art. The signals may travel via a communications path 626, which may be configured to carry the signals and may be implemented using wire, cable, fiber optics, a phone line, a cellular phone link, a radio frequency link, etc.

Computer program medium and computer usable medium may refer to memories, such as the main memory 608 and secondary memory 610, which may be memory semiconductors (e.g., DRAMs, etc.). These computer program products may be means for providing software to the computer system 600. Computer programs (e.g., computer control logic) may be stored in the main memory 608 and/or the secondary memory 610. Computer programs may also be received via the communications interface 624. Such computer programs, when executed, may enable computer system 600 to implement the present methods as discussed herein. In particular, the computer programs, when executed, may enable processor device 604 to implement the methods illustrated by FIGS. 3-5, as discussed herein. Accordingly, such computer programs may represent controllers of the computer system 600. Where the present disclosure is implemented using software, the software may be stored in a computer program product and loaded into the computer system 600 using the removable storage drive 614, interface 620, and hard disk drive 612, or communications interface 624.

Techniques consistent with the present disclosure provide, among other features, systems and methods for displaying targeted content on an article of clothing. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for displaying targeted content on an article of clothing, comprising:
storing, in a consumer database, a plurality of consumer profiles, wherein each consumer profile includes data related to a consumer including at least a consumer identifier and consumer behavioral data;
storing, in a content database, a plurality of content profiles, wherein each content profile includes data related to a visual content item including at least one or more selection criteria;
reading, by a reading device, payment card data corresponding to a payment card associated with a specific consumer, wherein the payment card data includes at least a specific consumer identifier associated with the specific consumer;
identifying, in the consumer database, a specific consumer profile where the included consumer identifier corresponds to the specific consumer identifier;
identifying, in the content database, a specific content profile based on the included at least one or more selection criteria and the consumer behavioral data included in the identified specific consumer profile; and
transmitting, by a transmitting device, the visual content item included in the identified specific content profile for display on an article of clothing directed toward the specific consumer.

2. The method of claim 1, wherein the visual content item is at least one of: an advertisement, offer, deal, discount, or coupon for a good or service.

3. The method of claim 1, wherein the visual content item is a data file having a media type corresponding to an image or video.

4. The method of claim 1, wherein the consumer behavioral data includes at least one of: transaction data, demographic data, advertising data, offer data, and consumer-supplied data.

5. The method of claim 1, wherein the consumer identifier is one of: a payment account number corresponding to the payment card and a name.

6. The method of claim 1, wherein reading the payment card data includes reading, by the reading device, card data encoded in a payment card and decoding, by a processing device, the read card data to obtain the payment card data.

7. The method of claim 1, wherein reading the payment card data includes reading, by the reading device, card data encoded in a machine-readable code and decoding, by a processing device, the read card data to obtain the payment card data.

8. The method of claim 1, wherein reading the payment card data includes receiving, by a receiving device, encrypted data via near field communication and decrypting, by a processing device, the received encrypted data to obtain the payment card data.

9. The method of claim 1, wherein the one or more selection criteria includes at least one model score, and identifying the specific content profile further includes:
identifying, based on at least the consumer behavioral data included in the specific consumer profile, a consumer score, and
identifying, by a processing device, the specific content profile based on a correspondence between the included at least one model score and the identified consumer score.

10. The method of claim 9, wherein
each content profile further includes a corresponding geographic location, and
identification of the specific content profile is further based on a distance between the included corresponding geographic location and a predetermined geographic location.

11. The method of claim 1, further comprising:
storing, in a memory, product data corresponding to one or more products to be purchased by the specific consumer, wherein
identification of the specific consumer profile is further based on the stored product data.

12. A system for displaying targeted content on an article of clothing, comprising:
a consumer database configured to store a plurality of consumer profiles, wherein each consumer profile includes data related to a consumer including at least a consumer identifier and consumer behavioral data;
a content database configured to store a plurality of content profiles, wherein each content profile includes data related to a visual content item including at least one or more selection criteria;
a reading device configured to read payment card data corresponding to a payment card associated with a specific consumer, wherein the payment card data includes at least a specific consumer identifier associated with the specific consumer;
a processing device configured to
identify, in the consumer database, a specific consumer profile where the included consumer identifier corresponds to the specific consumer identifier, and
identify, in the content database, a specific content profile based on the included at least one or more selection criteria and the consumer behavioral data included in the identified specific consumer profile; and
a transmitting device configured to transmit the visual content item included in the identified specific content profile for display on an article of clothing directed toward the specific consumer.

13. The system of claim 12, wherein the visual content item is at least one of: an advertisement, offer, deal, discount, or coupon for a good or service.

14. The system of claim 12, wherein the visual content item is a data file having a media type corresponding to an image or video.

15. The system of claim 12, wherein the consumer behavioral data includes at least one of: transaction data, demographic data, advertising data, offer data, and consumer-supplied data.

16. The system of claim 12, wherein the consumer identifier is one of: a payment account number corresponding to the payment card and a name.

17. The system of claim 12, wherein reading the payment card data includes reading, by the reading device, card data encoded in a payment card and decoding, by the processing device, the read card data to obtain the payment card data.

18. The system of claim 12, wherein reading the payment card data includes reading, by the reading device, card data encoded in a machine-readable code and decoding, by the processing device, the read card data to obtain the payment card data.

19. The system of claim 12, further comprising: a receiving device, wherein
reading the payment card data includes receiving, by the receiving device, encrypted data via near field communication and decrypting, by the processing device, the received encrypted data to obtain the payment card data.

20. The system of claim 12, wherein the one or more selection criteria includes at least one model score, and identifying the specific content profile further includes:
identifying, based on at least the consumer behavioral data included in the specific consumer profile, a consumer score, and
identifying, by the processing device, the specific content profile based on a correspondence between the included at least one model score and the identified consumer score.

21. The system of claim 20, wherein
each content profile further includes a corresponding geographic location, and
identification of the specific content profile is further based on a distance between the included corresponding geographic location and a predetermined geographic location.

22. The system of claim 12, further comprising:
a memory configured to store product data corresponding to one or more products to be purchased by the specific consumer, wherein
identification of the specific consumer profile is further based on the stored product data.
